(19) United States
(12) Patent Application Publication
(10) Pub. No.: US 2018/0264496 A1
(43) Pub. Date: Sep. 20, 2018

(54) TWIN BOTTLE MANIFOLD

(71) Applicant: MEDIMARK SCIENTIFIC LIMITED, Seal, Kent (GB)

(72) Inventors: David NORTON, Kent (GB); Ian ARCHARD, Kent (GB)

(73) Assignee: MEDIMARK SCIENTIFIC LIMITED, Seal, Kent (GB)

(21) Appl. No.: 15/762,348

(22) PCT Filed: Sep. 21, 2016
(86) PCT No.: PCT/GB2016/052945

§ 371 Date: Mar. 22, 2018

(30) Foreign Application Priority Data
Sep. 22, 2015 (GB) 1516795.0

(51) Int. Cl. B05B 11/00

(52) U.S. Cl. CPC B05B 11/3081; B05B 11/3011; B05B 11/0008

(57) ABSTRACT

A part of a dispensing apparatus is described. A fluid dispensing apparatus manifold arranged to mix and combine a first fluid from a first chamber and a second fluid from a second chamber has been devised. The manifold includes a first fluid inlet for entry of fluid from the first chamber, a second fluid inlet for entry of fluid from the second chamber, a mixing chamber and a fluid outlet. A first fluid passage is arranged to provide fluid communication for the first fluid from the first chamber to the mixing chamber, and a second fluid passage is arranged to provide fluid communication for the second fluid from the second chamber to the mixing chamber, whereby the first and second fluids are combined into a mixed fluid stream at the fluid outlet.

The invention relates to apparatus for ejecting or spraying a fluid stream or spray through a nozzle from out of a container or a bottle.

There are existing devices for hand pumping and spraying a fluid drawn in from a container out through a nozzle. Various pump apparatus and devices are used to draw the fluid up from the container, in combination with the actuation of a trigger the fluid is then expelled out through the nozzle. Where a single container and a single fluid is used then the nozzle or sprayer ejects only that particular fluid and fluid concentration that is in the container. Containers can be interchangeable with different fluids stored in different containers. By alternating the containers then a variety of fluids can be sprayed and expelled from the bottle.

The present invention seeks to improve existing devices for ejecting or spraying a fluid stream or spray from out of a container or bottle. In particular, through the use of existing bottles and trigger spray heads.

According to an aspect of the present invention there is provided a fluid dispensing apparatus manifold arranged to mix and combine a first fluid from a first chamber and a second fluid from a second chamber, the manifold comprising a first fluid inlet for entry of fluid from the first chamber, a second fluid inlet for entry of fluid from the second chamber, a mixing chamber and a fluid outlet, wherein a first fluid passage is arranged to provide fluid communication for the first fluid from the first chamber to the mixing chamber, and a second fluid passage is arranged to provide fluid communication for the second fluid from the second chamber to the mixing chamber, whereby the first and second fluids are combined into a mixed fluid stream at the fluid outlet

Some trigger spray devices can accommodate both a first and a second fluid but so far the devices have featured complex pump and spray combinations all housed within a trigger spray head. This type of integrated spray trigger and manifold structure must be specific to each system and often includes bottles specific to the design of spray trigger.

The complex nature of the apparatus could lead to blockages in the system and an increase in manufacture cost.

In an embodiment the fluid dispensing apparatus manifold comprises a mating portion located at the first fluid inlet arranged to mate with a bottle of standard construction and can comprise a mating portion located at the second fluid inlet arranged to mate with a bottle of standard construction. In an embodiment the first and second fluid inlets comprise one or more diptubes. This means that the apparatus manifold allows for the mixing of two fluids, two liquids in the embodiment described below, from adjacent discrete bottles using pre existing standard bottles. The manifold is shaped to fit together with the generic bottles and the diptubes with the manifold provide a device component for bringing together and mixing two liquids prior to dispensing.

The manifold of an embodiment further comprises a mating portion located at the fluid outlet and arranged to mate with a trigger sprayer device of standard construction. The dispensing of the combined, mixed liquid can then take place using a generic standard trigger spray head. This type of atomising dispensing head is readily available and a user is free to make use of existing supplies, reducing the cost of the system overall. The overall system enables components such as the bottles and trigger spray to be re used, further contributing to its cost effectiveness.

In an embodiment the manifold is comprised of two parts formed by injection moulding, secured together with a weld. The fabrication of the manifold of the embodiment is by standard techniques and operation. The embodiment described below should not be too large in order that it be easy to use and readily accepted for use by a user. The size should be suitable for retro fitting with existing equipment and the embodiment is of an ergonomic depth with user friendly features. The manifold of an embodiment has depth in the range of 80 to 110 mm, preferably 100 mm. The overall width of the embodiment is in the range of 60 to 100 mm, preferably 75 mm.

The benefits to the user of utilising the manifold of the present invention as described in the embodiment below are that two separate fluids are drawn up and mixed in the manifold and only there combined together into a mixed stream for ejection at the trigger spray. For fluids that comprise active liquid components or liquids that are activated when mixed together this means that activation and mixing occurs within the manifold and therefore can be guaranteed to have happened at the point of exit from the trigger spray, so at the location surface or point of use. This activation is crucial for example where the activated fluid mixture is a biocide or disinfectant or cleaning product.

To facilitate this controlled mixing, in an embodiment one or more of the said first fluid passage and the said second fluid passage of the fluid dispensing apparatus manifold further comprises a component arranged to allow fluid to flow in one direction only. In an embodiment one or more of the first inlet and the second inlet further comprises a component arranged to allow fluid to flow in one direction only. This means fluid is directed to flow in a direction to be mixed and then on to the spray outlet. The fluid flow direction component may comprise a valve. There may be no backflow of product through diptubes with this scheme. In an embodiment the first fluid inlet of the manifold is arranged to receive a stable liquid component in an unactivated state as a said first fluid and can be arranged so that the second fluid inlet is arranged to receive a stable liquid component in an unactivated state as a said second fluid.

In an embodiment the manifold mixing chamber is arranged to mix a first and a second fluid whereby the first and the second fluid are activated so as to form an active fluid component. The mixing and combining of the two fluids within the manifold before ejection from the trigger spray preserves the efficacy of a biocide or similar activated mixture.

Other products that exist to mix fluids together in a spray head effect the mixing of the fluids on ejection from the trigger spray or close to the spray head outlet. The resulting mist from the trigger spray may not be the product, for example, a cleaning product in its activated state. There is a risk that the spray emitted will merely be an atomised spray of two fluids from their respective separate sources, yet to be activated or only partially activated.

The user's pump action of the trigger spray or other negative pressure exertion pump device at the trigger spray head exerts a negative pressure within the first and second fluid passages and on the surface of the fluids in the first fluid chamber and second fluid chamber and at the fluid reservoirs, which in the illustration here would be existing bottles. The pressure differential felt at the surface of the fluids draws the fluids up into and along their respective passages. In an embodiment the manifold comprises a first fluid passage tube having a first diameter and the second fluid passage comprises a second fluid passage tube having a second diameter. In an embodiment the first and second fluid passage tubes have substantially the same diameter.

The ratio of the proportion of the fluids drawn up into the manifold can be monitored and controlled. The proportion of a fluid A to a fluid B (from a first and a second reservoir) is equal to the ratio of the cross sectional areas of the diptubes into the respective reservoirs, for fluids having the same viscosity. In an embodiment the first and second fluid passage tubes have different diameters. Where fluid passage tubes in the manifold have different diameters the user has the benefit of a tailoring the system to suit the ‘recipe’ and combination of fluid components required for the generation and functionality of the biocide at the exit of the trigger spray head.

For fluids having different viscosity the diameter of the first and second passages will be altered in the embodiment to match the ratio of the viscosity of each fluid. This means the rate of discharge of each of the respective fluids together at the outlet can also be adjusted. The ratio of the cross sectional areas of the passages within the manifold, the diptubes of the embodiment, are the tools available to tailor the ratios of the components within the mixture to be activated.

The system and the manifold may be used in extreme environments. The manifold may be part of a cleaning equipment piece for use in a hospital or other clean or disinfected location. In an embodiment, the components of the manifold and attachments are sterile.

According to a further aspect of the present invention there is provided a method of manufacture of a fluid dispensing apparatus manifold arranged to mix and combine a first fluid from a first chamber and a second fluid from a second chamber, the manifold comprising a first fluid inlet for entry of fluid from the first chamber, a second fluid inlet for entry of fluid from the second chamber, a mixing chamber and a fluid outlet, wherein a first fluid passage is arranged to provide fluid communication for the first fluid from the first chamber to the mixing chamber, and a second fluid passage is arranged to provide fluid communication for the second fluid from the second chamber to the mixing chamber, whereby the first and second fluids are combined into a mixed fluid stream at the fluid outlet.

Embodiments of the invention will now be described in detail, by way of example only, with reference to the accompanying drawings, in which:

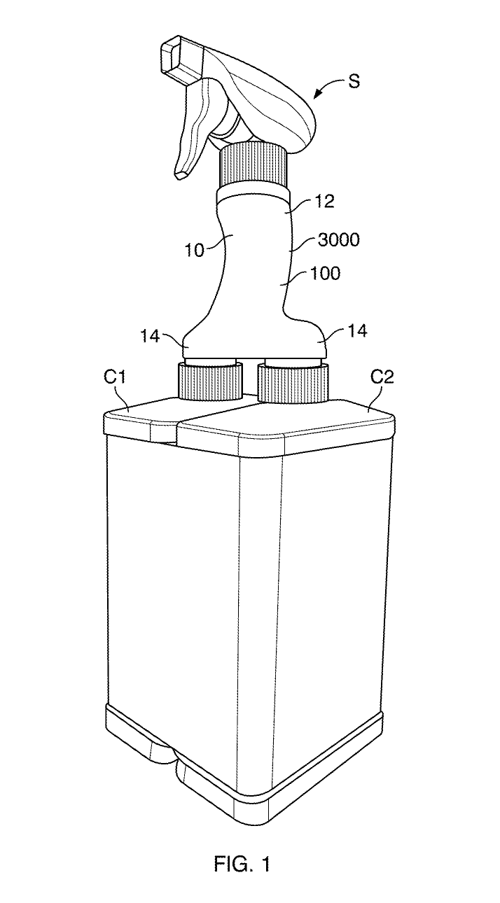

FIG. 1 is a perspective view of the twin bottle mixing manifold according to an embodiment of the invention, mounted on conventional bottles and attached to a standard trigger spray head;

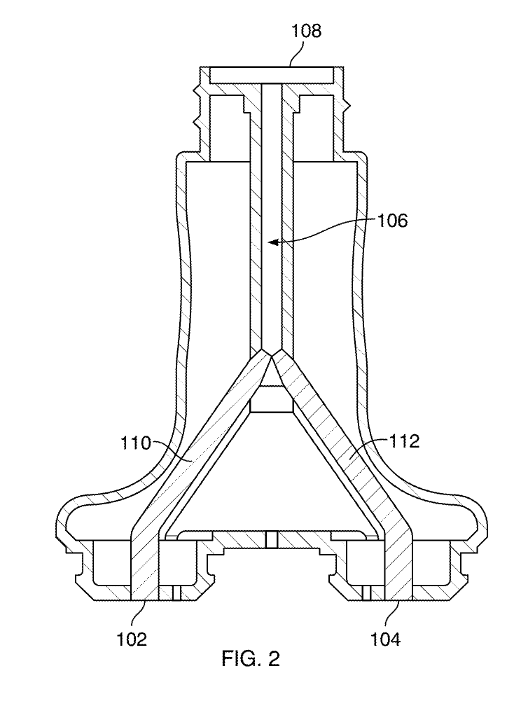

FIG. 2 is a front internal view of the manifold of FIG. 1;

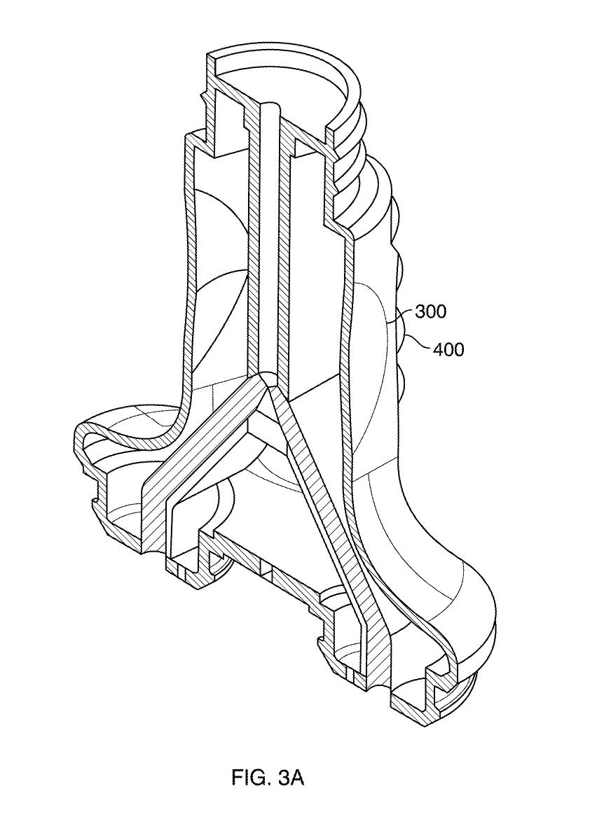

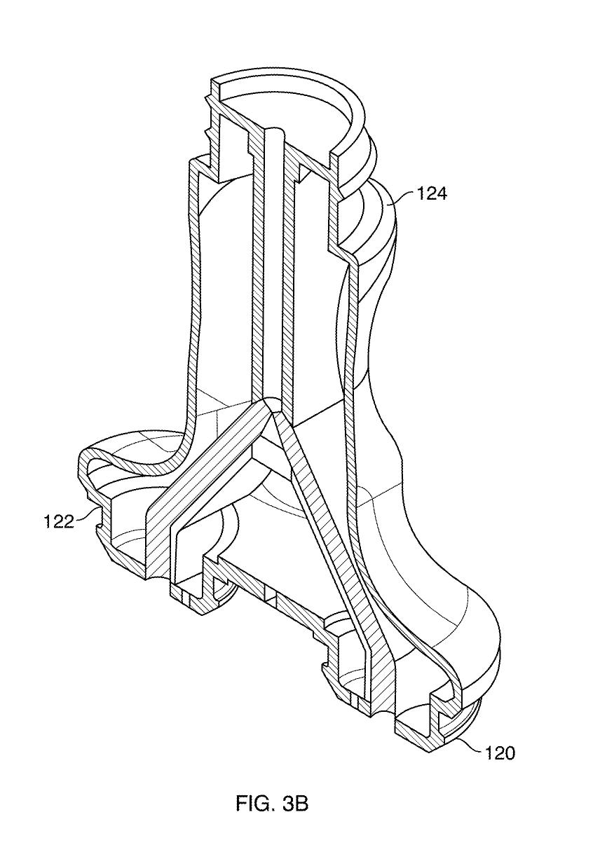

FIG. 3a is a perspective interior view of one half of the manifold of FIG. 1;

FIG. 3b is a perspective interior view of the corresponding other half part of the manifold of FIG. 1;

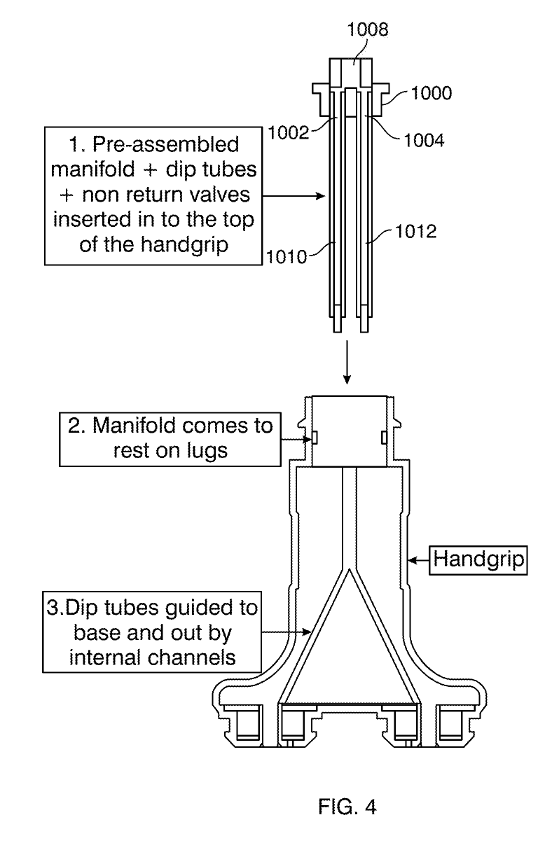

FIG. 4 is an exploded cross sectional view of an alternative embodiment showing the manifold inserted into a separate hand grip for mounting on conventional bottles and for attaching to a standard trigger spray head;

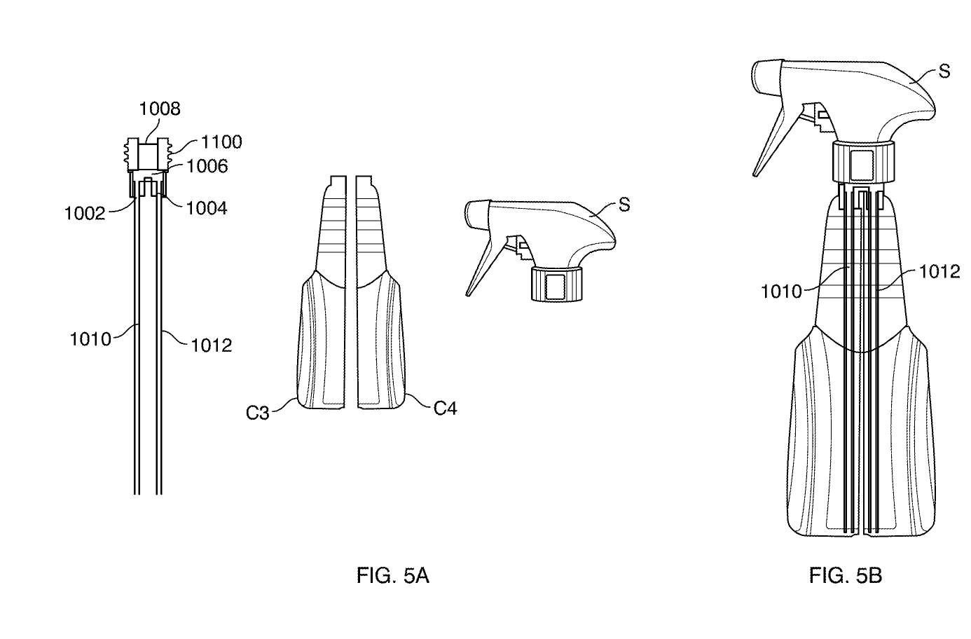

FIG. 5a is an exploded view of an alternative embodiment of the twin bottle manifold of the invention, and includes other components of the assembly such as the trigger spray and bottles; and

FIG. 5b shows an assembled view of the embodiment of the invention illustrated in FIG. 5a.

The upper and lower portions referred to in this description are those that, in use, are in the upper or topmost position when the apparatus is ready for use.

FIG. 1 shows the manifold 100 of the present invention in situ in a ready to use state with a fluid dispensing apparatus and a trigger spray head S. The manifold 100 comprises a neck 10, of a substantially cylindrical shape having a column diameter. The upper portion 12 of the neck 10 broadens to have a diameter wider than the manifold column diameter, and the lower portion of the neck 10 comprises a pair of shoulders 14 arranged to branch from the neck 10 and to connect to existing bottles or chambers. FIG. 1 shows chamber C1 and chamber C2 suitable for containing fluids for mixing in the manifold 100. The interior of the manifold 100 comprises portions suitable for the passage and mixing of fluids from the chambers C1, C2 through the manifold to the trigger spray head S. The manifold 100 comprises a first fluid inlet 102 for entry of fluid from the first chamber C1, a second fluid inlet 104 for entry of fluid from the second chamber C2, a mixing chamber 106 and a fluid outlet 108. In the illustration in FIG. 2 there is a first fluid passage 110 arranged to provide fluid communication for the first fluid from the first chamber C1 to the mixing chamber 106, and a second fluid passage 112 that is arranged to provide fluid communication for the second fluid from the second chamber C2 to the mixing chamber 106. The first fluid passage 110 extends from the fluid inlet 102 to the mixing chamber 106, it is a cylindrical tube and can comprise a diptube. The second fluid passage 112 extends from the fluid inlet 104 to the mixing chamber 106, it is a cylindrical tube and can comprise a diptube. As illustrated the tubes of this embodiment forming the passages are of equal diameter. A fluid passage then extends to the fluid outlet 108. The mixing chamber 106 is provided so that first and second fluids are combined into a mixed fluid stream at the fluid outlet 108.

The fluid inlets 102, 104 and fluid outlet 108 all comprise mating portions for connection to existing kit. Screw threaded portions 120, 122 are located below shoulders 14 and depend therefrom. The portions 120, 122 surround and protect first fluid inlet 102 and second fluid inlet 104. Portions 120 and 122 are supplied in preparation for connection to chambers C1 and C2, which in this embodiment are conventional bottles containing fluid components. Connecting portion 124 also features a screw threaded mating portion for connection to a standard spray trigger head S. First 110 and second 120 fluid passages may include one or more valves (not shown) for fluid direction control.

FIG. 3 shows the cut through view of the manifold. The two pieces comprise injection moulded portions and the two pieces can be joined together with weld points and heat sealing or similar to form a one piece manifold. The preferred dimensions of the fluid outlet 108 is 25 mm and the width of the lower portion of the neck is 75 mm.

In the illustrated embodiment the side face 300 of the neck of the manifold 100 comprises an ergonomically shaped region 400 provided for ease of hold and grip by a user. The shaping in FIG. 3 can comprise one or more shapes selected from the range; scalloped, chamfered, indented. The shapings should be able to easily accommodate the fingers and hand grip of a user. In addition the face 300 may comprise company or product information signage.

In use, the manifold combined with standard bottles and a spray head can provide on the spot activated fluid solution, for example a sporicidal spray. The user takes the lower part of the shoulders 14 of manifold 100 is connected with a screw thread to two standard bottles, chambers C1 and C2. The fluid in one chamber may be a hypochlorite and the fluid in the second chamber may be an adipic acid/ethanol mix. Diptubes from the manifold provide a first fluid inlet 102 and a second fluid inlet 104. A user connects the upper portion 12 of the manifold to a conventional trigger spray head S and when the activated solution is required the user draws up fluid from chamber C1 and chamber C2 by the pump action of the trigger spray. The fluids are drawn up from their respective chambers into the manifold at inlet 102 and inlet 104, they pass along their respective passages 110 and 112 to combine at the mixing chamber 106. The mixed stream provides an activated formula of active biocide, here Hypochlorous acid, that continues to be intimately mixed as it is ejected from the outlet 108 and via the trigger spray head S.

The ratio of the fluids from chamber C1 and chamber C2 are drawn up in a predetermined ratio equal to the ratio of the cross sectional area of passage 110 and passage 112. The rate of dispersion will also depends on the relative viscosity of the fluids and an appropriate adjustment in the ratio of the cross section of the tubes will provide a tailored activated solution.

The manifold may be of an alternative embodiment as required for bulk manufacture and as may be suited to producing the manifold and bottle arrangement on a large scale. For example, in an alternative embodiment the connection from the manifold to the bottles may be with a press fit. The manifold may comprise a neck portion only with a separate trigger, hand grip and portion for connection to the bottles. In this embodiment the hand grip includes internal channels to guide the dip tubes to the bottles. The valves for fluid control of the contents of the bottles, chambers C1 and C2 may be located inside the manifold or inside the hand grip or outer molded portion. Illustrated examples of this embodiment are shown in FIG. 4, in an exploded view. FIG. 5 also illustrates an alternative embodiment in which the bottles are molded in such a way so as to create a hand grip portion. In this version the bottles C3, C4 are not standard bottles and the manifold and a trigger head assembly is inserted into the bottles in a slot or push fit arrangement. In the embodiments illustrated in exploded view in FIG. 4 and FIG. 5, the invention is such that the interior of the manifold 1100 comprises portions suitable for the passage and mixing of fluids from the chambers C3, C4 through the manifold to the trigger spray head S. The manifold 1100 comprises a first fluid inlet 1002 for entry of fluid from the first chamber C3, a second fluid inlet 1004 for entry of fluid from the second chamber C4, a mixing chamber 1006 and a fluid outlet 1008. In the illustration in FIGS. 4 and 5 there is a first fluid passage 1010 arranged to provide fluid communication for the first fluid from the first chamber C3 to the mixing chamber 1006, and a second fluid passage 1012 that is arranged to provide fluid communication for the second fluid from the second chamber C4 to the mixing chamber 1006. The first fluid passage 1010 extends from the fluid inlet 1002 to the mixing chamber 1006, it is a cylindrical tube and can comprise a diptube. The second fluid passage 1012 extends from the fluid inlet 1004 to the mixing chamber 1006, it is a cylindrical tube and can comprise a diptube. As illustrated the tubes of the embodiments forming the passages are of equal diameter. A fluid passage then extends to the fluid outlet 1008. The mixing chamber 1006 is provided so that first and second fluids are combined into a mixed fluid stream at the fluid outlet 1008, as previously described.

Various modifications may be made to the described embodiments without departing from the scope of the present invention. The body may be of an alternative shaping and may comprise any suitable material and may be of varying length and thickness. Alternative forms of construction and features may be considered. The shape of the manifold may be of any shape to conform the hand of a user or to include other functional features. The inlet and outlets may be a suitable size in order to combine and fit with existing systems. The manifold may comprise plastic, injection moulded material or other task specific or site specific material. They may include sterilised components. The activated fluid ejected from the trigger may be a disinfectant, a biocde, a sporicidal spray. The number of passageways and inlets may be altered to allow for more than two reservoirs of fluids, for example 3 or 4 may be accommodated.

The manifold product may include signage selected from the range of; colourways, company name, hazard warnings, CE Standard and supporting information, indication of product or use by date.

1. A fluid dispensing apparatus manifold arranged to mix and combine a first fluid from a first chamber and a second fluid from a second chamber, the manifold comprising a first fluid inlet for entry of fluid from the first chamber, a second fluid inlet for entry of fluid from the second chamber, a mixing chamber and a fluid outlet, wherein a first fluid passage is arranged to provide fluid communication for the first fluid from the first chamber to the mixing chamber, and a second fluid passage is arranged to provide fluid communication for the second fluid from the second chamber to the mixing chamber, whereby the first and second fluids are combined into a mixed fluid stream at the fluid outlet.

2. A fluid dispensing apparatus manifold as claimed in claim 1, wherein the manifold comprises a mating portion located at the first fluid inlet arranged to mate with a bottle of standard construction.

3. A fluid dispensing apparatus manifold as claimed in claim 1, wherein the manifold comprises a mating portion located at the second fluid inlet arranged to mate with a bottle of standard construction.

4. A fluid dispensing apparatus manifold as claimed in claim 1, wherein the first and second fluid inlets comprise one or more diptubes.

5. A fluid dispensing apparatus manifold as claimed in claim 1, wherein the manifold further comprises a mating portion located at the fluid outlet arranged to mate with a trigger sprayer device of standard construction.

6. A fluid dispensing apparatus manifold as claimed in claim 1, wherein the manifold is comprised of two parts formed by injection moulding.

7. A fluid dispensing apparatus manifold as claimed in claim 6, wherein the two parts are secured together with a weld.

8. A fluid dispensing apparatus manifold as claimed in claim 1, having a depth in the range of 80 to 110 mm, preferably 100 mm.

9. A fluid dispensing apparatus manifold as claimed in claim 1, having a width in the range of 60 to 100 mm, preferably 75 mm.

10. A fluid dispensing apparatus manifold as claimed in claim 1, wherein one or more of the said first fluid passage and the said second fluid passage further comprises a component arranged to allow fluid to flow in one direction only.

11. A fluid dispensing apparatus manifold as claimed in claim 1, wherein one or more of the first inlet and the second inlet further comprises a component arranged to allow fluid to flow in one direction only.

12. A fluid dispensing apparatus manifold as claimed in claim 10, wherein the fluid flow direction component comprises a valve.

13. A fluid dispensing apparatus manifold as claimed in claim 1, wherein the first fluid inlet is arranged to receive a stable liquid component in an unactivated state as a said first fluid.

14. A fluid dispensing apparatus manifold as claimed in claim 1, wherein the second fluid inlet is arranged to receive a stable liquid component in an unactivated state as a said second fluid.

15. A fluid dispensing apparatus manifold as claimed in claim 1, wherein the mixing chamber is arranged to mix a first and a second fluid whereby the first and the second fluid are activated so as to form an active fluid component.

16. A fluid dispensing apparatus manifold as claimed in claim 15, wherein the first and the second fluid are activated so as to form an active biocide, sporicide, or other activated formula.

17. A fluid dispensing apparatus manifold as claimed in claim 1, wherein the first fluid passage comprises a first fluid passage tube having a first diameter and the second fluid passage comprises a second fluid passage tube having a second diameter.

18. A fluid dispensing apparatus manifold as claimed in claim 17, wherein the first and second fluid passage tubes have substantially the same diameter.

19. A fluid dispensing apparatus manifold as claimed in claim 17, wherein the first and second fluid passage tubes have different diameters.

20. A fluid dispensing apparatus manifold as claimed in claim 1, wherein the components of the manifold and attachments are sterile.

21. (canceled)
